(19) United States
(12) Patent Application Publication
(10) Pub. No.: US 2026/0016295 A1
(43) Pub. Date: Jan. 15, 2026

(54) MEASURING DEVICE

(71) Applicant: STABILA MESSGERÄTE Gustav Ullrich GmbH, Annweiler (DE)

(72) Inventors: Gabriel KALLABIS, Spirkelbach (DE); Joachim STILZ, Sinsheim (DE)

(73) Assignee: STABILA MESSGERÄTE Gustav Ullrich GmbH, Annweiler (DE)

(21) Appl. No.: 19/260,731

(22) Filed: Jul. 7, 2025

(30) Foreign Application Priority Data
Jul. 11, 2024 (DE) 20 2024 103 864.9

(51) Int. Cl. G01C 15/00

(52) U.S. Cl. CPC G01C 15/004

(57) ABSTRACT

A measuring device (10) having a housing (12) with side walls (18, 20) and end wall (22) with an aperture (26) for a beam to exit. A covering element (28) pivotably connected to the housing extends along the end wall having the aperture in a basic position. A sliding element (40) is slidably arranged along the side wall having the aperture and is slidable into a first end position closing the aperture in the side wall when the covering element (28) is in the basic position, wherein the covering element is unpivotable when the sliding element is in the first end position.

### CROSS-REFERENCE TO RELATED APPLICATIONS

This application claims priority to German utility application 20 2024 103 864.9 filed on Jul. 11, 2024. The content of this application is incorporated herein by reference in its entirety.

The invention relates to a measuring device, in particular to a line laser, having a housing with a first and a second side wall, a first and a second end wall, a top wall and a bottom wall, which each have outer faces, wherein one of the end walls and at least one side wall adjoining it, in particular both side walls, have an aperture for a beam exit, a covering element pivotably connected to the housing and extending in a basic position at least in some sections along the end wall having the aperture and along the bottom wall and/or top wall, and a switch for switching the device off and on.

A corresponding measuring device is known from EP 1 939 588 B1. According to one example, the cover, which also serves as a holder, is U-shaped in section and can optionally cover or uncover an aperture present in the end wall of the measuring device housing and passed though by a laser beam. The cross member of the cover covering the aperture can here have mounting and fixing means, such as magnets, on the outside to enable positioning of the device in a required position to then emit laser beams and project lines, for example. Connecting threads for fastening the device, for example on a tripod, may be provided in the bottom-side member of the cover.

If a measuring device has beam exit apertures, which may merge into one another, present in both side walls too, the beam passing through the end wall, however not that through the side walls, may then be covered by the cover.

There is also the possibility of the device being switched on when the end wall is covered, as a result of which damage might occur.

The object underlying the present invention is to develop a measuring device of the type mentioned at the outset such that the beam exit aperture is protected against damage when the device is not in use.

According to a further aspect, an uncontrolled switch-on of the device should not be possible.

To achieve at least one of the aspects, the invention provides that a sliding element is slidably arranged along the side wall(s) having the aperture, that the sliding element is slidable into a first end position closing the aperture in the side wall(s) when the covering element is in the basic position, and that the covering element or the housing is unpivotable when the sliding element is in the first end position.

In particular, the invention is characterized in that a first projection extends from a section of the sliding element extending along the bottom wall of the housing; that in one section of the covering element extending along the bottom wall a first recess extends along a straight line, in which recess the first projection is then only slidable when the covering element is covering the end wall of the housing with the beam exit aperture present therein, wherein pivoting of the covering element is prevented when the first projection is engaged in the first recess and wherein the covering element is designed pivotable when the first projection is not engaged in the first recess, wherein the sliding element is unslidable when the covering element is pivoted.

It is ensured by the teachings in accordance with the invention that when the device is not in use, the aperture in the end wall and the aperture present in the at least one side wall, in particular the apertures present in both side walls, are covered such that they are protected. If the device is dropped, for example, no damage is incurred here.

It is in particular provided here that the covering element is U-shaped, wherein the cross member extending along the end wall having the aperture merges into side members which extend along the top wall and bottom wall and which are in turn passed through by a rotation axis, about which the covering element or the housing is rotatable or pivotable relative to the covering element. The rotation axis should here extend between the first end wall and the outer wall of a storage battery accommodated for example in a receptacle provided in the one end wall opposite to the end wall with the aperture, in order to allow operation of the device such that the covering element is pivotable 360° without any problem, thereby simplifying its handling. At the same time, however, the cross member should, when aligned on the end wall having the aperture, extend along it closely.

In order to ensure that the covering element or the housing can only be pivoted when the sliding element is in the second basic position, i.e. in that position in which the aperture present in the at least one side wall, preferably in both side walls, is uncovered, it is in particular provided that the bottom wall of the housing has or is passed through by a stud-like second projection which engages in a second recess, such as a passage opening, of the associated cross member of the covering element; that the second recess is surrounded concentrically by a receptacle; that the first recess extends from the receptacle in the longitudinal direction of the covering element; and that the first projection extends from the member of the sliding element extending along the bottom wall, which is movable or slidable only in the basic position of the covering element in the first recess. It is thus ensured that the sliding element can be slid from a second basic position into the first basic position only when the cross member of the covering element is extending along the end wall of the housing. Conversely, the covering element or the housing can be pivoted only when the sliding element is in its second basic position. Otherwise, the first projection engaging in the first recess prevents pivoting of the covering element.

The receptacle has for that purpose an outer limit which the first projection is in contact with when the covering element is pivoted out of the basic position. It is thus ensured that the sliding element cannot be moved out of its second basic position when the covering element is pivoted.

It is proposed in accordance with the invention that the beam exit apertures in the end wall and in the two side walls, which as already mentioned may merge into one another, are covered, i.e. not only the beam exit aperture on the end wall.

Additionally, and if appropriate in isolation and in independently inventive manner, it can be ensured that the device is neither switched on nor can be switched on when covering is in effect.

To do so, the sliding element is provided, which can be moved manually from its first end position into a second end position. The first end position is reached when the sliding element, which is in particular of planar design, closes the beam exit aperture in the side wall, wherein it is in particular provided that each of the side walls has a beam exit aperture which is then covered by the sliding element, wherein the beam exit apertures in particular merge into one another, so that a line can be projected by means of the device onto a building wall, for example, without any problem.

When the sliding element is in the second end position, the measuring device is switchable on and off in the usual way, i.e. the function of the switch is not restricted.

To provide this possibility, it is in particular provided that the switch has a actuating element for changing the switch from its OFF setting to the ON setting and vice versa, that the sliding element has a recess which is passed through by the actuating element and has a driver interacting with the actuating element, which prevents a movement of the actuating element out of the OFF setting of the switch when the sliding element is in the first end position, and that the sliding element uncovers the switch in its second end position in which the apertures are uncovered, i.e. that the switch is movable into its ON setting, wherein during sliding of the sliding element from the second end position into the first end position while the switch is in the ON setting the latter is switched from the ON setting to the OFF setting by the interaction of the actuating element with the driver. It is thus ensured that the device is switched off when the beam exit aperture is covered. It is also ensured in accordance with the invention that switching on of the device is ruled out when the beam exit aperture is covered.

Beam exit aperture refers to the apertures present in the end wall and the side walls and that should merge into one another.

A solution of simple design is characterized in that the switch is preferably a slide switch with a projection, such as a bar, as the actuating element, and the driver of the sliding element is a limit to the recess into which the projecting section of the switch extends.

It must furthermore be noted that the sliding element is slidable both from the first end position into the second end position and from the second end position into the first end position only when the covering element is in its basic position in which the end beam exit aperture is covered.

The covering element or the housing should be able to be pivoted only when the sliding element is in its second end position.

The sliding element has two side members along the side walls and cross members connecting them, which extend along the top and bottom walls and connect the side members to one another.

To ensure dependable guidance of the sliding element, having in section vertical to the longitudinal axis of the sliding element a rectangular shape, projections extend from the inner faces of the side members and from the cross members of the sliding element and engage in grooves extending in the longitudinal direction of the housing or vice versa.

In particular, two projections extend from each side member and/or cross member, in particular both from the side members and from the cross members, and engage in two corresponding grooves in the side, top and bottom walls to permit dependable guidance of the sliding element. Several projections may of course also engage in one groove.

The plurality of projections and grooves basically represents a redundancy. However, it permits problem-free sliding regardless of the possible shrinkage of the material and of the thin-walled sliding element, which consists of plastic.

The outer face of the cross member of the covering element may have, in the usual way, mounting aids for fixing the device in a required position at one location. In particular, magnets are provided as mounting aids.

The bottom wall of the covering element may for example have a connecting thread to allow the measuring device to be fastened on a tripod.

Further details, advantages and features of the invention are derived not just from the claims and the features contained therein—singly and/or in combination,—but also from the following description of a preferred example.

The drawing shows in:

FIG. 1 a line laser in the operating position,

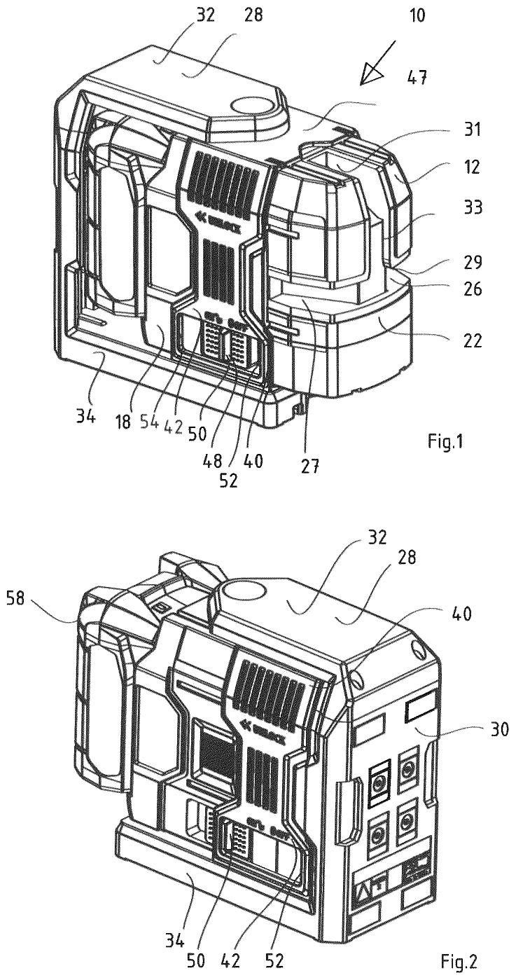

FIG. 2 the line laser according to FIG. 1 when not in use,

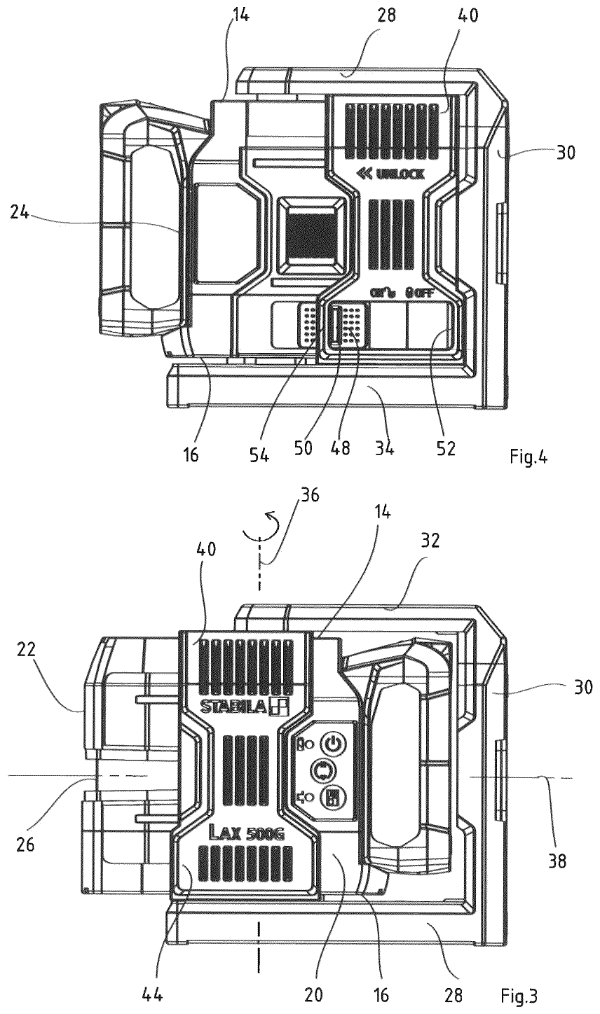

FIG. 3 a side view of the line laser according to FIGS. 1 and 2 in the operating position,

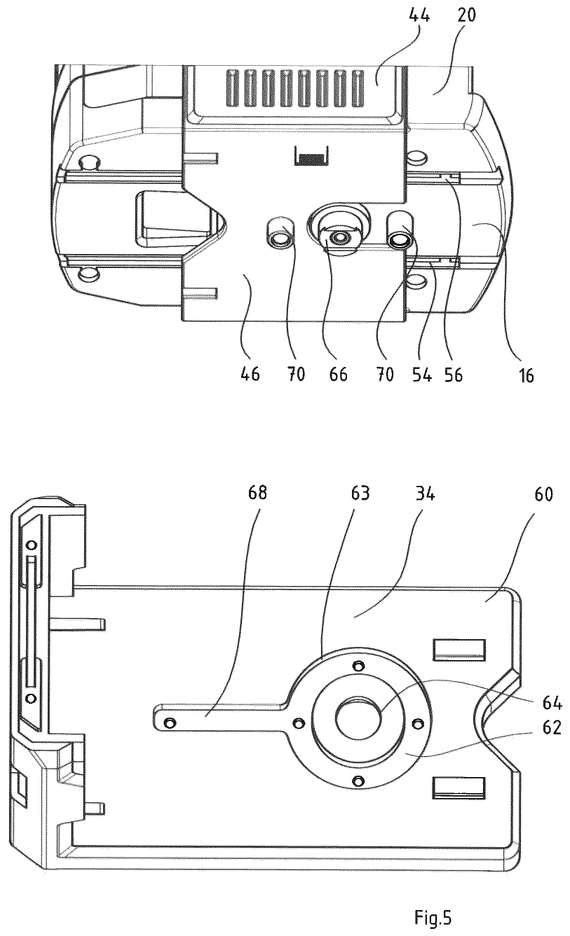

FIG. 4 the line laser according to FIGS. 1 to 3 in the not-in-use position, and

FIG. 5 the underside of the line laser with associated member of a covering element in an exploded view.

The teachings in accordance with the invention of a measuring device 10 are intended to be explained on the basis of a line laser.

As may be seen in the figures, the measuring device 10 has a cuboid housing 12 with a top wall 14, a bottom wall 16, opposite side walls 18, 20, and end walls 22, 24. In the example, an electro-optical device, self-uprighting by force of gravity and by which a perpendicular or horizontal laser beam is generatable in order to image a perpendicular or horizontal light line, is arranged inside the housing 12.

To allow the laser beam to exit, the housing 12 has an aperture 26 that extends along the end wall 22, sections of the adjoining side walls 18, 20 and the top wall 14, as shown in self-explanatory form by the illustrations. The corresponding sections 27, 29, 31, 33 of the aperture 26, which merges from the end wall 22 into the side walls 18, 20 and top wall 14, are U-shaped when seen in the horizontal section of the housing 12. The region of the aperture 26, that merges starting from the end wall 16 into the top wall 14, is L-shaped in the vertical section and in the longitudinal direction of the housing.

The bottom wall 16 likewise has an aperture to allow imaging of a perpendicular beam that also passes through the section 31 of the aperture 26 in the top wall 14.

Furthermore, a covering element 28 is provided, in particular also serving as a handle or holder, which has a U-geometry with cross member 30 and with side members 32, 34 which extend transversely, in particular vertically, to the cross member 30. The side members 32, 34 and hence the covering element 28 are connected to the housing 12—i.e. to the top wall 14 and to the bottom wall 16—pivotably about an axis 36. The pivot axis 36 vertically intersects the longitudinal axis 38 of the housing 12.

In order to ensure, when the device 10 is not in use, that the aperture 26, i.e. the sections 27, 29, 31, 33 and the laser beam exit aperture in the bottom, are covered and that at the same time pivoting of the covering element 28 or housing 12 relative to the covering element 28 is ruled out, a design is proposed as explained in the following in connection with FIG. 5. A sliding element 40 is provided that has planar members 42, 44 extending along the side walls 18, 20 and connected by a cross member 47 extending along the top wall 14. The members 42, 44 furthermore merge into a cross member 46 extending along the bottom wall 16.

The sliding element 40 may consist of plastic and be thin-walled. Other materials, such as sheet metal, may also be used.

If the sections 27, 29 in the side walls 18, 20 and the aperture passing through the bottom wall 16 are covered by the sliding element 40, the cross member 30 of the covering element 28 extends along the end wall 22 on the aperture side, wherein pivoting of the covering element 28 or of the housing 12 is ruled out, so that the laser beam exit apertures are completely protected and hence damage is ruled out if the device 10 is for example dropped. The end wall 22 is first covered by the cross member 30 of the covering element 28, in order to then slide the sliding element 40 in the direction of the cross member 30 for covering the remaining apertures or their sections 27, 29, 31, and to position it in its first end position.

According to an independently inventive aspect of the invention, it may also be ensured by means of the sliding element 40 that when the apertures are covered an inadvertent switch-on of the device 10 is ruled out, and when the device 10 is switched off it cannot be switched on if the apertures are covered by the sliding element 40.

As may be seen in FIGS. 1, 2 and 4, a switch 48, designed as a slide switch in the example, is located in the side wall 18. The switch is moved in the longitudinal axis direction of the housing 12.

The switch 48 has a bar-like projection 50 using which it can be actuated. The projection 50 as the actuating element extends inside a recess 52 of the member 42 of the sliding element 40. The recess 52 has a rectangular geometry limited by rims, of which one rim is identified with the reference number 54 and extends vertically to the longitudinal axis 38 of the housing 12 and along the member 42 of the sliding element 40. This rim 54 interacts with the projection 50 of the switch 48 in the way indicated below in order to automatically move the switch 48 into the OFF setting by sliding the sliding element 40, i.e. to switch off the device 10 when the sections of the aperture 26 in the side walls (sections 27, 29) and in some cases one in the top wall 14 (section 31) are covered using the sliding element 40, and the section 33 of the aperture 26 in the end wall 22 by the cross member 30 of the covering element 28. The remaining region of the aperture in the top wall is covered by the side member 32 of the covering element 28.

A movement of the sliding element 40 into the position closing those sections 27, 29 of the aperture 26 extending in the side walls 18, 20 is however only possible when the cross member 30 of the covering element 28 extends along the end wall 22, i.e. its side members 32, 34 are aligned along the bottom and top walls 14, 16, so that the aperture in the bottom wall 16, the section 33 extending in the end wall 22 and the section 31 of the aperture 26 extending in the top wall 14 are covered by the cross member 30 and the side members 32, 34.

Only in this position of the covering element 28 is there also the possibility to move the sliding element 40 in the direction of the end wall 22 to allow covering of those sections 27, 29 of the aperture 26 extending in the side walls 18, 20. During this sliding movement, the rim 54 of the aperture 52 of the sliding element 40 interacts with the bar-like projection 50 of the switch 48 such that the latter is moved to the OFF setting. Switching on of the device 10 is now no longer possible. This cannot be done until the sliding element 40 has been moved into the position shown in FIGS. 1, 3, in which it is possible to pivot the covering element 28 or the housing 12 in order to uncover the aperture 26 to the required extent and to enable the laser beam to exit.

To permit dependable guidance of the sliding element 40, projections extend from the inner faces of the side members and cross members 42, 44, 46, 48, and engage in grooves in the longitudinal direction of the housing 12. By way of example, grooves 54, 56 are shown in the bottom wall 16 in FIG. 5.

A storage battery 58 connected to the electro-optical device in the housing 12 is insertable on the rear face of the housing 12 opposite the aperture 26.

Pivoting of the covering element 28 is ruled out in the position in which the sliding element 40 closes those sections 27, 29 of the aperture 26 in the side walls 18, 20 and further movement of the sliding element 46 is prevented because the latter is in contact with the cross member 30 of the covering element 28. As a result, the device 10 is transportable without any problem and the risk of inadvertent switch-on is ruled out.

This non-pivoting is explained in more detail based on FIG. 5, in which the bottom wall 16 of the housing 12 and the inner face 60 of the side member 34 of the covering element 28 are opposite one another. A stud-like projection 66, about which the covering element 28 or the housing 12 is rotatable relative to the covering element 28, extends from the bottom wall 16.

The inner face 60 of the side member 34 has a recess 64, such as a hole, which is surrounded concentrically by an annular receptacle 62. The stud-like projection 66, referred to as the second projection, engages in the recess 64, referred to as the second recess, in order to allow pivoting of the covering element 28 or the housing 12 as already mentioned. A—first—recess, such as a groove 68, extending along a straight line in the longitudinal direction of the side member 34 of the covering element 28, extends from the annular receptacle 62, which is an indentation in the inner face 60 of the side member 34. A—first—projection 70, which must be aligned on the groove 68 to enable sliding of the sliding element 40, extends from the outer face of the cross member 46 of the sliding element 40. This is the case when the covering element 28 is in its basic position, in which the side members 32, 34 are aligned with their longitudinal axes on the longitudinal axis 38 of the housing 12, i.e. the side members 32, 34 thus extend along the top wall 14 and the bottom wall 16. At the same time, the cross member 30 is then aligned on the end wall 22 of the housing 12 and covers it, such that the sections 31, 33 of the aperture 26 that extend along the end wall 26 and the top wall 40 are covered. The projection 70 is then aligned on the groove 68, so that the sliding element 40 can be slid in the direction of the end wall 22 and hence the cross member 30, to the extent that the outer rim of the sliding element 40 is in contact with the cross member 30, i.e. with its lateral rims. This should be the first end position of the sliding element 40. Pivoting of the covering element 28 or the housing 12 is no longer possible due to the engagement of the projection 70 in the groove 68.

To permit pivoting, the sliding element 40 must have been slid into its second end position, as shown in FIG. 1. The same is the case from the side view according to FIG. 3. In this position, the projection 70 disengages from the groove 68, with the result that pivoting of the covering element 28 is possible. At the same time, sliding of the sliding element 40 is ruled out when the covering element 28 is pivoted, as the projection 70 would come up against the all-round rim 63 of the receptacle 62 if a movement were to be attempted. A dual function is thus met by the receptacle 62 with the linear groove 68 extending from it, allowing either pivoting of the covering element 28 or the housing 12, or sliding of the sliding element 40.

Support during pivoting is furthermore provided by a projection 72 protruding from the bottom wall 16 of the housing 12 and in contact with the limit 63 of the receptacle 62 during pivoting of the covering element 28.

The covering element 28, also serving as a handle or holder, has mounting and fixing means to allow arrangement of the device 10 in a required position. In particular, the mounting and fixing means are magnets.

Furthermore, a connection may for example be provided in the bottom wall 16 to allow the device to be fixed on a tripod.

What is claimed is:

1. A measuring device (10), in particular a line laser, comprising:
a housing (12) with a first and a second side wall (18, 20), a first and a second end wall (22, 24), a top wall (14) and a bottom wall (16), which each have an outer face,
wherein one of the end walls and at least one side wall adjoining the latter, in particular both side walls, have an aperture (26) for a beam exit, a covering element (28) pivotably connected to the housing and extending in a basic position at least in some sections along the end wall having the aperture and along the bottom and/or top wall, and
a sliding element (40) slidably arranged along the side wall (18) or side walls (18, 20) having the apertures (26, 27, 29),
wherein the sliding element is slidable into a first end position closing the aperture in the side wall(s) when the covering element (28) is in the basic position, and
wherein the covering element is unpivotable when the sliding element is in the first end position.

2. The measuring device according to claim 1,
wherein a first projection (70) extends from a section of the sliding element (40) extending along the bottom wall (16) of the housing (12), that in a section of the covering element (28) extending along the bottom wall a first recess (64) extends along a straight line in which the first projection is only slidable when the covering element is covering the end wall (22) of the housing (12) with the beam exit aperture (26) present therein, and
wherein pivoting of the covering element is prevented when the first projection engages in the first recess, and when the first projection and the first recess are not engaged the covering element is designed pivotable with simultaneous non-slidability of the sliding element (40).

3. The measuring device according to claim 1,
wherein a stud-like second projection (66) extends from the bottom wall (16) of the housing (12) or passes through it, about which projection the covering element (28) is rotatable or pivotable; and
wherein the second projection (66) engages in or passes through a second recess (64), such as a passage opening, of the covering element (28);
wherein the second recess is surrounded concentrically by a receptacle (62) from which extends the first recess (68), such as a groove, extending along a straight line in the longitudinal direction of the covering element; and
wherein the first projection (70) extends from the member (46) of the sliding element (40) extending along the bottom wall, which is slidable only when the cross member (30) of the covering element is aligned on the end wall (22) having the aperture (26) inside the first recess.

4. The measuring device according to claim 1,
wherein the receptacle (62) has an outer limit (63) with which the first projection (70) extending from the cross member (46) of the sliding element (40) is in contact or at a short distance therefrom when the covering element (28) is pivoted out of the basic position.

5. The measuring device preferably according to claim 1,
wherein the measuring device has a switch (48) for switching on and off, and
wherein the switch (48) extends from one of the side walls (18);
wherein the sliding element (40) is movable along the side wall and interacts with the switch such that the switch is in its OFF setting when the sliding element is covering the aperture(s) (27, 29) passing through the side wall(s) (18, 20), switching is prevented, and the sliding element is in the first end position; and
wherein the sliding element is designed movable into a second end position in which the aperture is not covered by the sliding element and the switch is settable.

6. The measuring device according to claim 5,
wherein the switch (48) has an actuating element (50) for changing the switch from its ON setting to the OFF setting and vice versa, and
wherein the sliding element (40) has a recess (52) which is passed through by the actuating element and has a driver (54) interacting with the actuating element such that movement of the actuating element of the switch out of the OFF setting is prevented when the sliding element is in the first end position.

7. The measuring device according to claim 1,
wherein the switch (48) is a slide switch with a projecting section (50), such as a bar, as the actuating element, and
wherein the driver (54) is a limit (54) to the recess (52).

8. The measuring device according to claim 1,
wherein, when the sliding element (40) is moved from the second end position to the first end position while the switch is in the ON setting, the latter is switched from the ON setting to the OFF setting by the interaction of the actuating element with the driver of the switch (48).

9. The measuring device according to claim 1,
wherein the sliding element (40) is slidable both from the first end position into the second end position and from the second end position into the first end position only when the covering element (28) is in its basic position covering the aperture (33) passing through the end wall (22).

10. The measuring device according to claim 1,
wherein the covering element (28) is pivotable only when the sliding element (40) is in the second end position.

11. The measuring device according to claim 1,
wherein the sliding element (40) has a first and a second side member (42, 44), which are connected by at least one cross member (47) extending along the top and/or bottom wall (14, 16) of the housing (12), in particular cross members (46, 47) extending along both the top wall and the bottom wall of the housing (12).

12. The measuring device according to claim 1,
wherein at least one projection extends from each of the side members (42, 44) and from the at least one cross member (46, 47) of the sliding element (40) and engages in grooves (54, 56) extending in the longitudinal direction of the housing (12), or vice versa, when the sliding element (40) is slid guided by the facing walls (14, 16, 18, 20) of the housing (12).

13. The measuring device according to claim 1,
wherein the end wall (24) of the housing (12) opposite the aperture (26) has a receptacle for a storage battery (58).

14. The measuring device according to claim 1,
wherein the covering element (28) is U-shaped with a cross member (30) alignable along the end wall (22) having the aperture (26) and with side members (32, 34) extending therefrom along the top and/or bottom wall (14, 16), which members are in turn passed through by an axis (36) for pivoting of the covering element or the housing (12).

15. The measuring device according to claim 1,
wherein the axis (36) extends between the end wall (22) having the aperture (26) and the outer wall of a storage battery (58) extending from the opposite end wall (24) such that the covering element (28) or the housing (12) is pivotable 360°.
